(19) United States
(12) Patent Application Publication
(10) Pub. No.: US 2005/0083477 A1
(43) Pub. Date: Apr. 21, 2005

(54) Thin film transistor array panel and liquid crystal display including the panel

(76) Inventors: Soon-Il Ahn, Busan-si (KR); Jeong-Uk Heo, Yongin-si (KR)

Correspondence Address: F. CHAU & ASSOCIATES, LLC, 130 WOODBURY ROAD, WOODBURY, NY, 11797, US

(21) Appl. No.: 10/935,916

(22) Filed: Sep. 8, 2004

(30) Foreign Application Priority Data
Sep. 9, 2003 (KR) 2003-63332

(51) Int. Cl. G02F 1/1339

(52) U.S. Cl. 349/156

(57) ABSTRACT

A liquid crystal display device comprises a first panel including a plurality of pixel electrodes, a second panel positioned opposite the first panel and including a common electrode, and a plurality of members positioned between the first and second panels for electrically connecting the first and second panels, wherein at least one of the plurality of members is spaced apart from aligned corners of the first and second panels by a predetermined distance.

### BACKGROUND OF THE INVENTION

(a) Technical Field

The present disclosure relates to a thin film transistor array panel and a liquid crystal display including the panel.

(b) Discussion of the Related Art

Liquid crystal displays (LCDs) are one of the most widely used flat panel displays. An LCD includes two panels having field-generating electrodes, a gap interposed therebetween, a liquid crystal (LC) layer filled in the gap, and a plurality of spacers sustaining the gap.

The LCD displays images by applying voltages to the field-generating electrodes to generate an electric field in the LC layer, which determines orientations of LC molecules in the LC layer to adjust polarization of incident light.

Among LCDs including field-generating electrodes on respective panels, some LCDs provide a plurality of pixel electrodes arranged in a matrix on one panel referred to as a thin film transistor (TFT) array panel and a common electrode covering an entire surface of the other panel referred to as a common electrode panel. The image display of the LCD is accomplished by applying individual data voltages to the respective pixel electrodes and applying a common voltage to the common electrode. For the application of the individual data voltages, a plurality of three-terminal TFTs are connected to the respective pixel electrodes. A plurality of gate lines transmitting signals for controlling the TFTs and a plurality of data lines transmitting voltages to be applied to the pixel electrodes are provided on the TFT array panel. The common voltage is transmitted from an external voltage source to the common electrode panel via the TFT array panel.

The transmission of the common voltage from the TFT array panel to the common electrode panel is performed by a plurality of short members made of silver (Ag) paste. The short members are disposed out of a display area for displaying images and they are distributed over corners of the panels for uniform distribution of the common voltages on the common electrode, thereby decreasing flickering to obtain reliable display characteristics.

The short members at the corners are apt to be detached from one or both panels during the cutting of the panels after injecting liquid crystal in the gap between the panels. In particular, the short members placed at the corner made by edges of the panels, which are aligned with each other, are easily detached from the panels, thereby deteriorating display characteristics.

### SUMMARY OF THE INVENTION

A liquid crystal display device, in accordance with an embodiment of the present invention, comprises a first panel including a plurality of pixel electrodes, a second panel positioned opposite the first panel and including a common electrode, and a plurality of members positioned between the first and second panels for electrically connecting the first and second panels, wherein at least one of the plurality of members is spaced apart from aligned corners of the first and second panels by a predetermined distance.

The predetermined distance may be measured along an edge of at least one the first panel and the second panel and may be greater than about 5 mm. A plurality of gate lines and a plurality of data lines may be formed on the first panel. The plurality of members may be positioned outside of a display area where the plurality of gate lines and the plurality of data lines intersect. The at least one of the plurality of members spaced apart from the aligned corners may be positioned near an edge of the first panel and an edge of the second panel, wherein the edge of the first panel is aligned with the edge of the second panel.

A plurality of connection areas may be positioned on the first panel, the plurality of gate lines and the plurality of data lines being connected to driving circuits at the connection areas. At least one of the plurality of members may be located between at least two of the plurality of connection areas approximately equidistant from the connection areas. The at least one of the plurality of members spaced apart from the aligned corners may be positioned on a side of the first panel not including the plurality of connection areas.

A plurality of signal lines may be formed on the first panel for supplying a common voltage to the plurality of members. One of the plurality of signal lines may electrically connect at least two of the plurality of members. A passivation layer may be formed on the plurality of signal lines, wherein the passivation layer includes a plurality of contact holes exposing portions of the plurality of signal lines. A plurality of contact assistants may be formed on the passivation layer, wherein the contact assistants are connected to the exposed portions of the plurality of signal lines through the plurality of contact holes, and wherein each of the plurality of members is disposed on at least two of the contact assistants. A liquid crystal layer may be interposed between the first panel and the second panel. The plurality of members may supply a common voltage to the common electrode.

A panel configuration for a display device, in accordance with an embodiment of the present invention, comprises a first panel including a plurality of pixel electrodes, a second panel positioned opposite the first panel and including a common electrode, and a plurality of members positioned between the first and second panels for electrically connecting the first and second panels, wherein at least one of the plurality of members is spaced apart from a corner of at least one of the first and second panels by a predetermined distance along an edge of at least one of the first and second panels.

A display device, in accordance with an embodiment of the present invention, comprises a thin film transistor array panel, a common electrode panel positioned opposite the thin film transistor array panel, and a plurality of members positioned between the thin film transistor array and common electrode panels for electrically connecting the thin film transistor array and common electrode panels, wherein at least one of the plurality of members is spaced apart from aligned corners of the thin film transistor array and common electrode panels by a predetermined distance.

The predetermined distance may be measured along an edge of the thin film transistor array panel and an edge of the common electrode panel, the edges of the thin film transistor array panel and the common electrode panel being aligned with each other.

A thin film transistor array panel, in accordance with an embodiment of the present invention, comprises a plurality of members formed thereon for supplying a common voltage to a common electrode panel positioned opposite the thin film transistor array panel, wherein at least one of the plurality of members is spaced apart from a corner of the thin film transistor array panel by a predetermined distance measured along an edge of the thin film transistor array panel.

The corner and edge of the thin film transistor array panel may be aligned with a corner and edge of the common electrode panel.

### BRIEF DESCRIPTION OF THE DRAWINGS

Preferred embodiments of the present invention can be understood in more detail from the following descriptions taken in conjunction with the accompanying drawings in which:

FIG. 1 is a schematic diagram of an LCD according to an embodiment of the present invention;

FIG. 2 is a layout view of a TFT array panel for an LCD according to an embodiment of the present invention;

FIG. 3 is a sectional view of the LCD including the TFT array panel shown in FIG. 2 taken along the line III-III′ according to an embodiment of the present invention; and

FIG. 4 is a sectional view of the LCD shown in FIG. 1 taken along the line IV-IV′ and a connection area according to an embodiment of the present invention.

### DETAILED DESCRIPTION OF THE PREFERRED EMBODIMENTS

Preferred embodiments of the present invention now will be described more fully hereinafter with reference to the accompanying drawings. The present invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present.

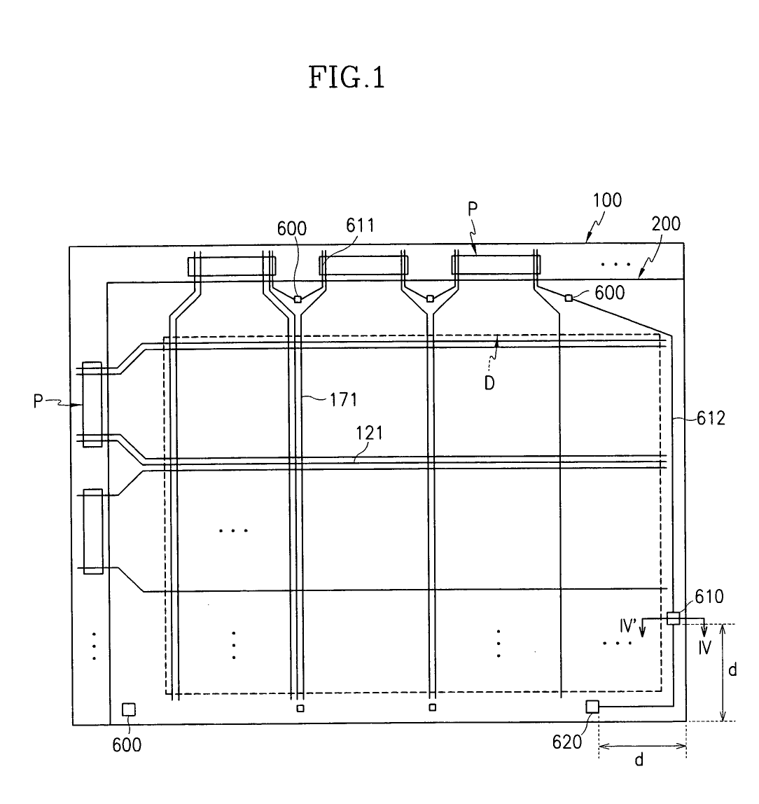

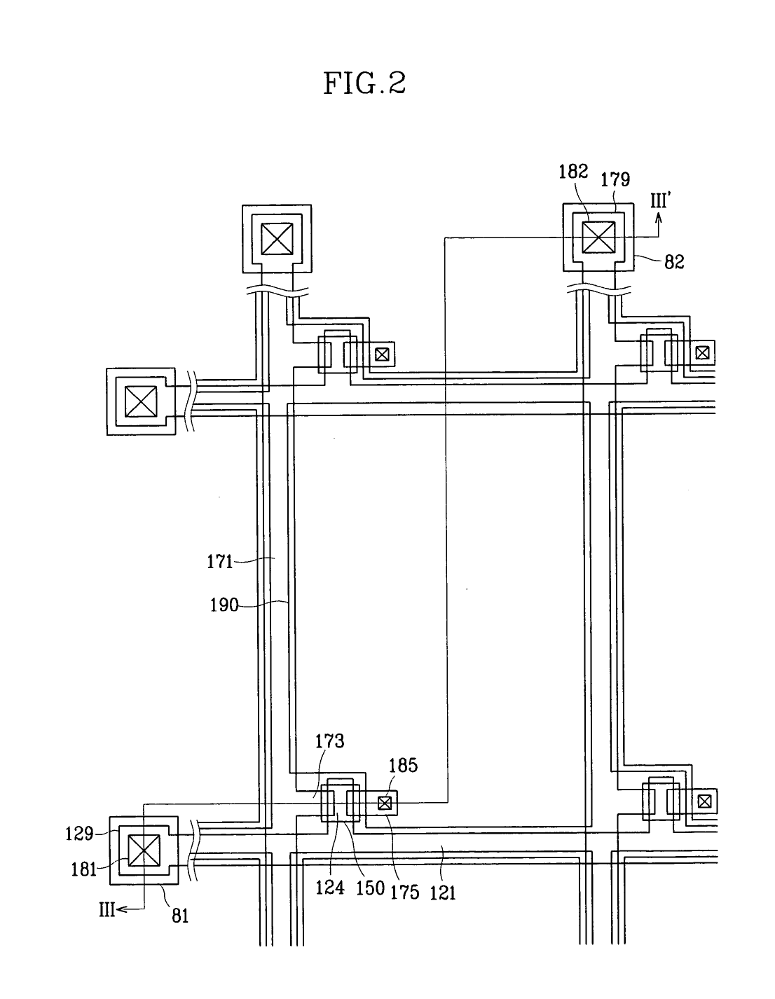

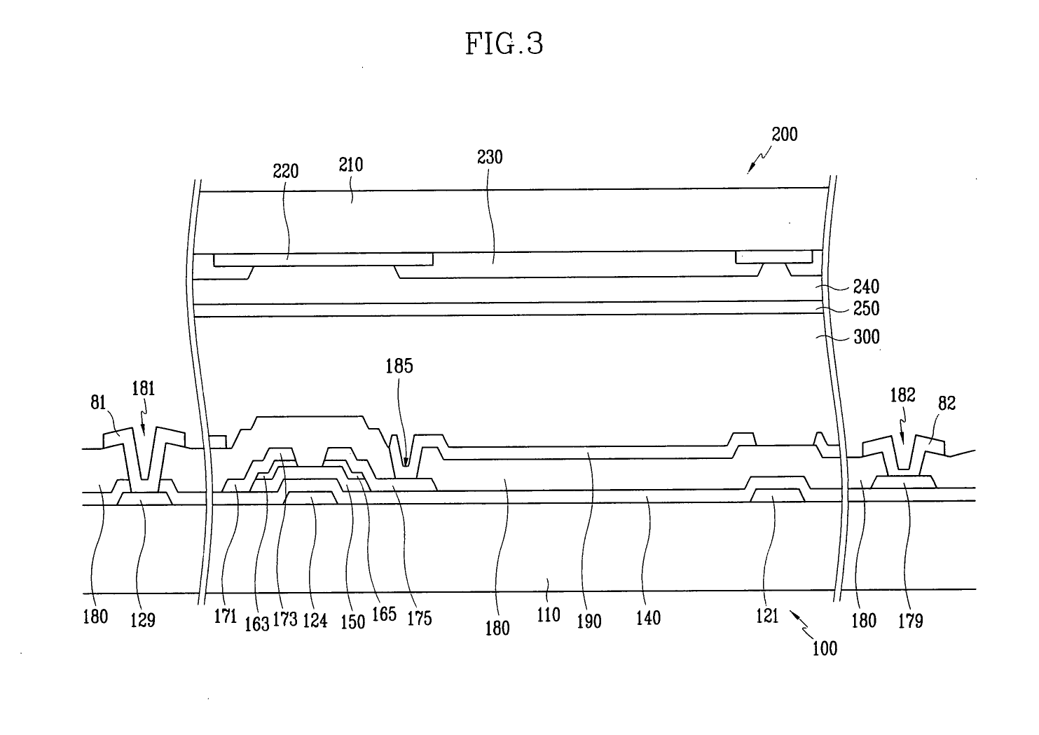

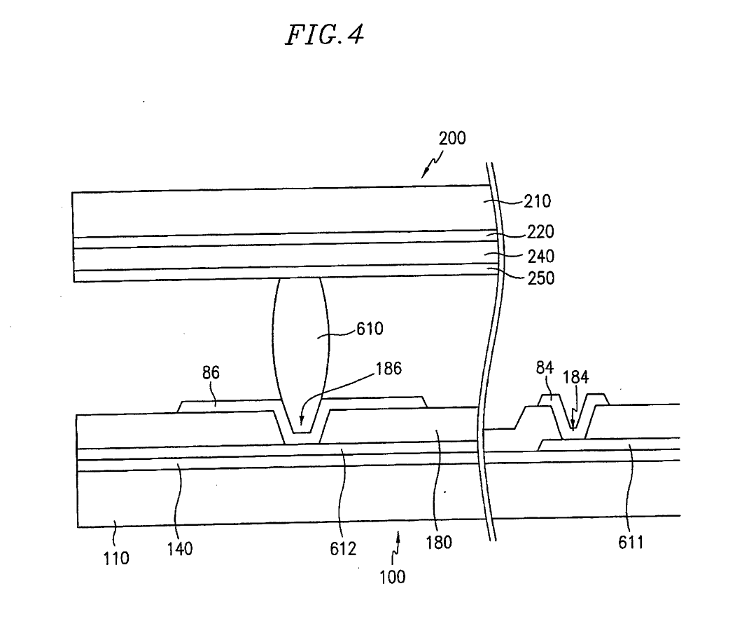

FIG. 1 is a schematic diagram of an LCD according to an embodiment of the present invention, FIG. 2 is a layout view of a TFT array panel for an LCD according to an embodiment of the present invention, FIG. 3 is a sectional view of the LCD including the TFT array panel shown in FIG. 2 taken along the line III-III′ according to an embodiment of the present invention, and FIG. 4 is a sectional view of the LCD shown in FIG. 1 taken along the line IV-IV′ and a connection area according to an embodiment of the present invention.

Referring to FIGS. 1 and 3, an LCD according to an embodiment of the present invention includes a TFT array panel 100, a common electrode panel 200, an LC layer 300 interposed between the panels 100 and 200, and a plurality of short members 600, 610 and 620 for electrically connecting the two panels 100 and 200.

Referring to FIGS. 1-4, the TFT array panel 100 includes a plurality of gate lines 121 extending in a transverse direction, a plurality of data lines 171 extending in a longitudinal direction, and a plurality of pixel electrodes 190 connected to the gate lines 121 and the data lines 171 through switching elements provided on the TFT array panel 100. The gate lines 121 and the data lines 171 intersect in a display area D enclosed by the dotted rectangle shown in FIG. 1 and the gate and data lines 121, 171 extend to be gathered group by group at connection areas P, which are not covered by the common electrode panel 200. The gate lines and the data lines 121 and 171 are connected to driving integrated circuits at the connection areas P and the driving circuits may be integrated into the TFT array panel 100, or mounted on the panel 100 or on other printed circuit films (not shown) in the form of chips.

Referring to FIGS. 3 and 4, the common electrode panel 200 includes a common electrode 250 for generating an electric field in cooperation with the pixel electrodes 190 in the TFT array panel 100.

The short members 600 are disposed out of the display area D, but overlap both the TFT array panel 100 and the common electrode panel 200. The short members 600 are approximately equidistant from surrounding connection areas P and preferably made of Ag paste, but may be made from other suitable material for transmitting voltage. The short members 600 are supplied with a common voltage through a plurality of signal lines 611 and 612 connected to external devices and/or elements through the connection areas P and transmit the common voltage to the common electrode 250 of the common electrode panel 200.

A plurality of short members 610 and 620 are disposed out of the display area D near edges of the panels 100 and 200 on sides opposite the connection areas P for uniform voltage distribution of the common voltage around the common electrode 250. In other words, the short members 610 and 620 are disposed near the edges of the panels 100 and 200 aligned with each other, and the matching edges of the panels 100 and 200 are formed by simultaneously scribing the panels 100 and 200. The outer signal line 612 extends along the edge of the panels 100 and 200 to electrically connect the short member 610, the short member 600, and the short member 620. The short members 610 and 620 are spaced apart from a corner along respective edges by a distance d larger than about 5 mm. The short members 610 and 620 may be alternatively employed.

The short members 610 and 620 at the above-described positions are not easily detached from the panels 100, 200 since they are removed from the corner where the impact under the cutting of the panels 100 and 200 is severe, thereby reducing the effect of the impact. Accordingly, the positioning of the short members 610 and 620 increases the reliability of the electrical contact between the panels 100 and 200.

The TFT array panel 100 is now described in detail.

A plurality of gate lines 121 for transmitting gate signals are formed on an insulating substrate 110. The gate lines 121 extend substantially in a transverse direction and are separated from each other. Each gate line 121 includes a plurality of projections forming a plurality of gate electrodes 124 and an expanded end portion 129 having a large area for contact with another layer or an external device and/or element.

A plurality of storage electrodes supplied with a predetermined voltage such as a common voltage also may be formed on the substrate 110.

The gate lines 121 are preferably made of Al and Al alloy, Ag containing metal such as Ag and Ag alloy, Cu containing metal such as Cu and Cu alloy, Cr, Mo, Mo alloy, Ta, or Ti. The gate lines 121 may have a multi-layered structure. The gate lines 121 may include two films having different physical characteristics, a lower film and an upper film. The upper film is preferably made of low resistivity metal including Al containing metal such as Al and Al alloy for reducing signal delay or voltage drop in the gate lines 121. The lower film is preferably made of material such as Cr, Mo, Mo alloy, Ta and Ti, which have good physical, chemical, and electrical contact characteristics with other materials such as indium tin oxide (ITO) and indium zinc oxide (IZO). An example of the combination of the lower film material and the upper film material is Cr and Al-Nd alloy, respectively.

In addition, as shown in FIG. 3, the lateral sides of the gate lines 121 are inclined relative to a surface of the substrate 110, and the inclination angle thereof ranges from about 20 to about 80 degrees.

A gate insulating layer 140 made of, for example, silicon nitride (SiNx) is formed on the gate lines 121.

A plurality of semiconductor islands 150 made of, for example, hydrogenated amorphous silicon (abbreviated to “a-Si“) are formed on the gate insulating layer 140. Each semiconductor island 150 is disposed over the gate electrodes 124. The semiconductor islands 150 may extend in a longitudinal direction.

A plurality of ohmic contacts 163 and 165 made of, for example, silicide or n+ hydrogenated a-Si heavily doped with n type impurity are formed on the semiconductor islands 150. The ohmic contacts 163 and 165 are located in pairs on the semiconductor islands 150.

The lateral sides of the semiconductor islands 150 and the ohmic contacts 163 and 165 are inclined relative to a surface of the substrate 110, and the inclination angles thereof are preferably in a range between about 30 and about 80 degrees.

A plurality of data lines 171, a plurality of drain electrodes 175, and a plurality of signal lines 611 and 612 are formed on the ohmic contacts 163 and 165 and the gate insulating layer 140.

As shown in FIG. 2, the data lines 171 for transmitting data voltages extend substantially in the longitudinal direction and intersect the gate lines 121. Each data line 171 includes an expansion 179 having a larger area for contact with another layer or an external device and/or element.

A plurality of branches of each data line 171, which project toward the drain electrodes 175, form a plurality of source electrodes 173 partly enclosing one end of each of a plurality of drain electrodes 175. Each pair of the source electrodes 173 and the drain electrodes 175 are separated from each other and opposite each other with respect to a gate electrode 124. A gate electrode 124, a source electrode 173, and a drain electrode 175 along with a semiconductor island 150 form a TFT having a channel formed in the semiconductor island 150 disposed between the source electrode 173 and the drain electrode 175.

The signal lines 611 and 612 transmit the common voltage and have a large width for preventing the distortion of the common voltage. The signal lines 611 and 612 may be made from the same layer as the gate lines 121.

A plurality of storage capacitor conductors (not shown) overlapping the gate lines 121 or the above-described storage electrodes may be formed on the gate insulating layer 140.

The data lines 171, the drain electrodes 175, and the signal lines 611 and 612 are preferably made of refractory metal such as Cr, Mo, Mo alloy, Ta or Ti. They may include a lower film preferably made of Mo, Mo alloy or Cr and an upper film located thereon and preferably made of Al containing metal or Ag containing metal.

Like the gate lines 121, the data lines 171, the drain electrodes 175, and the signal lines 611 and 612 have tapered lateral sides relative to the surface of the substrate 110, and the inclination angles thereof range from about 30 to about 80 degrees.

The ohmic contacts 163 and 165 are interposed between the underlying semiconductor islands 150 and the overlying data lines 171 and the overlying drain electrodes 175 thereon and reduce the contact resistance between the underlying and overlying elements. The semiconductor islands 150 include a plurality of exposed portions, which are not covered with the data lines 171 and the drain electrodes 175, such as portions located between the source electrodes 173 and the drain electrodes 175.

Referring to FIGS. 3 and 4, a passivation layer 180 is formed on the data lines 171, the drain electrodes 175, the signal lines 611 and 612, and the exposed portions of the semiconductor islands 150. The passivation layer 180 is made of, for example, photosensitive organic material having good flatness characteristics, a low dielectric insulating material having a dielectric constant lower than about 4.0 such as a-Si:C:O and a-Si:O:F formed by plasma enhanced chemical vapor deposition (PECVD), an inorganic material such as silicon nitride, or any combination thereof.

The passivation layer 180 has a plurality of contact holes 182, 184, 185 and 186 exposing the end portions 179 of the data lines 171, end portions of the signal lines 611 and 612, the drain electrodes 175, and middle portions of the signal lines 611 and 612, respectively. The passivation layer 180 and the gate insulating layer 140 have a plurality of contact holes 181 exposing the end portions 129 of the gate lines 121.

A plurality of pixel electrodes 190, a plurality of contact assistants 81, 82, 84 and 86, which are made of, for example, ITO or IZO, are formed on the passivation layer 180.

The pixel electrodes 190 are physically and electrically connected to the drain electrodes 175 through the contact holes 185 such that the pixel electrodes 190 receive the data voltages from the drain electrodes 175.

The pixel electrodes 190 supplied with the data voltages generate electric fields in cooperation with the common electrode 250 on the common electrode panel 200, which orient the liquid crystal molecules in the liquid crystal layer 300.

A pixel electrode 190 and the common electrode 250 form a liquid crystal capacitor, which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrodes 190 with a previous gate line or a separate conductor such as the storage electrode.

The pixel electrodes 190 may overlap the gate lines 121 and the data lines 171 to increase aperture ratio.

The contact assistants 81, 82, 84 and 86 are connected to the exposed expansions 129 of the gate lines 121, the exposed expansions 179 of the data lines 171, the exposed end portions of the signal lines 611 and 612, and the exposed middle portions of the signal lines 611 and 612 through the contact holes 181, 182, 184 and 186, respectively. The contact assistants 81, 82, 84 and 86 protect the exposed portions 129, 179, and the exposed end and middle portions of the signal lines 611, 612, and complement the adhesion of the exposed portions 129, 179, and the exposed end and middle portions of the signal lines 611, 612, with external devices and/or elements and the short members 600, 610 and 620. Each of the short members 600, 610 or 620 is disposed on at least two of the contact assistants 86, minimizing the contact resistance between the exposed portions of the signal lines and the short members.

According to another embodiment of the present invention, a plurality of metal islands (not shown) preferably made from the same layer as the gate lines 121 or the data lines 171 are disposed on the substrate 110 and connected to the contact assistants 81, 82 and 84 through contact holes (not shown) at the passivation layer 180 or the gate insulating layer 140.

The description of the common electrode panel 200 follows.

A light blocking member 220 is formed on an insulating substrate 210 such as transparent glass. The light blocking member 220 has a plurality of open areas facing the pixel electrodes 190.

A plurality of red, green and blue color filters 230 are formed on the substrate 210 and the light blocking member 220. The color filters 230 are disposed in the open areas defined by the light blocking member 220 and edges of the color filters 230 overlap the light blocking member 220. Although the FIG. 3 shows that the color filters 230 are spaced apart from each other, they may overlap each other. An overcoat 240 is formed on the color filters 230 and the light blocking member 220. The overcoat 240 is made of, for example, insulating material and has a flat top surface.

A common electrode 250 made of, for example, transparent conductive material such as ITO and IZO is formed on the overcoat 240. The common electrode 250 is supplied with the common voltage as described above.

The signal lines 611 and 612 may include metal pieces made from, for example, the same layer as the gate lines 121, which contact the contact assistants 86.

The color filters 230 may be disposed on the TFT array panel 100.

At least one of the pixel electrodes 190 and the common electrode 250 may have cutouts (not shown) for determining tilt directions of the liquid crystal molecules under the electric field generated by the pixel electrodes 190 and the common electrode 250. Alternatively, a plurality of protrusions (not shown) may be provided on the pixel electrodes 190 or the common electrode 250. In this case, the liquid crystal layer 300 preferably has negative dielectric anisotropy and it is in a vertical alignment mode. As described above, the effect of the impact due to the cutting of the panels exerted on the short members can be reduced by placing the short members to be spaced apart from the corner formed by matching edges of the panels. Accordingly, the reliability of the electrical contact between the panels is improved.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

1. A liquid crystal display device, comprising:
a first panel including a plurality of pixel electrodes;
a second panel positioned opposite the first panel and including a common electrode; and
a plurality of members positioned between the first and second panels for electrically connecting the first and second panels, wherein at least one of the plurality of members is spaced apart from aligned corners of the first and second panels by a predetermined distance.

2. The liquid crystal display device as recited in claim 1, wherein the predetermined distance is measured along an edge of at least one the first panel and the second panel.

3. The liquid crystal display device as recited in claim 1, wherein the predetermined distance is greater than about 5 mm.

4. The liquid crystal display device as recited in claim 1, further comprising:
a plurality of gate lines formed on the first panel;
a plurality of data lines formed on the first panel; and
a display area wherein the plurality of gate lines and the plurality of data lines intersect, the plurality of members being positioned outside the display area.

5. The liquid crystal display device as recited in claim 1, wherein the at least one of the plurality of members spaced apart from the aligned corners is positioned near an edge of the first panel and an edge of the second panel.

6. The liquid crystal display device as recited in claim 5, wherein the edge of the first panel is aligned with the edge of the second panel.

7. The liquid crystal display device as recited in claim 1, further comprising:
a plurality of gate lines formed on the first panel;
a plurality of data lines formed on the first panel;
a plurality of connection areas positioned on the first panel, wherein the plurality of gate lines and the plurality of data lines are connected to driving circuits at the connection areas, and wherein at least one of the plurality of members is located between at least two of the plurality of connection areas.

8. The liquid crystal display device as recited in claim 7, wherein the at least one of the plurality of members located between the at least two of the plurality of connection areas is positioned approximately equidistant from the at least two of the plurality of connection areas.

9. The liquid crystal display device as recited in claim 7, wherein the at least one of the plurality of members spaced apart from the aligned corners is positioned on a side of the first panel not including the plurality of connection areas.

10. The liquid crystal display device as recited in claim 1, further comprising a plurality of signal lines formed on the first panel for supplying a common voltage to the plurality of members.

11. The liquid crystal display device as recited in claim 10, wherein one of the plurality of signal lines electrically connects at least two of the plurality of members.

12. The liquid crystal display device as recited in claim 10, further comprising a passivation layer formed on the plurality of signal lines, wherein the passivation layer includes a plurality of contact holes exposing portions of the plurality of signal lines.

13. The liquid crystal display device as recited in claim 12, further comprising a plurality of contact assistants formed on the passivation layer, wherein the contact assistants are connected to the exposed portions of the plurality of signal lines through the plurality of contact holes, and wherein each of the plurality of members is disposed on at least two of the contact assistants.

14. The liquid crystal display device as recited in claim 1, further comprising a liquid crystal layer interposed between the first panel and the second panel.

15. The liquid crystal display device as recited in claim 1, wherein the plurality of members supply a common voltage to the common electrode.

16. A panel configuration for a display device, comprising:
a first panel including a plurality of pixel electrodes;
a second panel positioned opposite the first panel and including a common electrode; and
a plurality of members positioned between the first and second panels for electrically connecting the first and second panels, wherein at least one of the plurality of members is spaced apart from a corner of at least one of the first and second panels by a predetermined distance along an edge of at least one of the first and second panels.

17. The panel configuration as recited in claim 16, wherein the predetermined distance is greater than about 5 mm.

18. The panel configuration as recited in claim 16, further comprising:
a plurality of connection areas positioned on the first panel for connecting a plurality of gate lines and a plurality of data lines to driving circuits, wherein at least one of the plurality of members is located between at least two of the plurality of connection areas.

19. The panel configuration as recited in claim 18, wherein the at least one of the plurality of members located between the at least two of the plurality of connection areas is positioned approximately equidistant from the at least two of the plurality of connection areas.

20. The panel configuration as recited in claim 18, wherein the at least one of the plurality of members spaced apart from the corner of at least one of the first and second panels is positioned on a side of the first panel not including the plurality of connection areas.

21. The panel configuration as recited in claim 16, further comprising:
a plurality of signal lines formed on the first panel for supplying a common voltage to the plurality of members;
a passivation layer formed on the plurality of signal lines, wherein the passivation layer includes a plurality of contact holes exposing portions of the plurality of signal lines; and
a plurality of contact assistants formed on the passivation layer, wherein the contact assistants are connected to the exposed portions of the plurality of signal lines through the plurality of contact holes, and wherein each of the plurality of members is disposed on at least two of the contact assistants.

22. The panel configuration as recited in claim 16, wherein the plurality of members supply a common voltage to the common electrode.

23. A display device, comprising:
a thin film transistor array panel;
a common electrode panel positioned opposite the thin film transistor array panel; and
a plurality of members positioned between the thin film transistor array and common electrode panels for electrically connecting the thin film transistor array and common electrode panels, wherein at least one of the plurality of members is spaced apart from aligned corners of the thin film transistor array and common electrode panels by a predetermined distance.

24. The display device as recited in claim 23, wherein the predetermined distance is measured along an edge of the thin film transistor array panel and an edge of the common electrode panel, the edges of the thin film transistor array panel and the common electrode panel being aligned with each other.

25. The display device as recited in claim 23, wherein the predetermined distance is greater than about 5 mm.

26. A thin film transistor array panel, comprising:
a plurality of members formed thereon for supplying a common voltage to a common electrode panel positioned opposite the thin film transistor array panel, wherein at least one of the plurality of members is spaced apart from a corner of the thin film transistor array panel by a predetermined distance measured along an edge of the thin film transistor array panel.

27. The thin film transistor array panel as recited in claim 26, wherein the predetermined distance is greater than about 5 mm.

28. The thin film transistor array panel as recited in claim 26, wherein the corner is aligned with a corner of the common electrode panel.

29. The thin film transistor array panel as recited in claim 26, wherein the edge is aligned with an edge of the common electrode panel.

30. The thin film transistor array panel as recited in claim 26, further comprising:
a plurality of gate lines and a plurality of data lines formed thereon; and
a plurality of connection areas formed thereon, wherein the plurality of gate lines and the plurality of data lines are connected to driving circuits at the connection areas, and wherein at least one of the plurality of members is located between at least two of the plurality of connection areas.

31. The thin film transistor array panel as recited in claim 30, wherein the at least one of the plurality of members located between the at least two of the plurality of connection areas is positioned approximately equidistant from the at least two of the plurality of connection areas.

32. The thin film transistor array panel as recited in claim 26, further comprising:
a plurality of signal lines formed thereon for supplying the common voltage to the plurality of members;
a passivation layer formed on the plurality of signal lines, wherein the passivation layer includes a plurality of contact holes exposing portions of the plurality of signal lines; and
a plurality of contact assistants formed on the passivation layer, wherein the contact assistants are connected to the exposed portions of the plurality of signal lines through the plurality of contact holes, and wherein each of the plurality of members is disposed on at least two of the contact assistants.
